(19) United States
(12) Patent Application Publication
(10) Pub. No.: US 2025/0074770 A1
(43) Pub. Date: Mar. 6, 2025

(54) LITHIUM SULFIDE PRODUCTION AND PURIFICATION METHODS

(71) Applicant: Solid Power Operating, Inc., Louisville, CO (US)

(72) Inventors: Brian E. Francisco, Arvada, CO (US); Samuel M. Oberwetter, Lafayette, CO (US); Benjamin A. Carlson, St. Paul, MN (US)

(21) Appl. No.: 18/818,303

(22) Filed: Aug. 28, 2024

Related U.S. Application Data
(60) Provisional application No. 63/534,976, filed on Aug. 28, 2023.

(51) Int. Cl. C01B 17/30

(52) U.S. Cl. CPC C01B 17/30; C01P 2006/40

(57) ABSTRACT

Provided herein are methods of preparing Li₂S. The methods generally include combining an alkaline metal sulfide, a lithium salt, an alcohol, and a hydrocarbon to form a mixture. A reaction forms the Li₂S. A dense solvent is then added to the mixture and the Li₂S is isolated from the mixture.

### CROSS-REFERENCE TO RELATED APPLICATION

This application is related to and claims priority under 35 U.S.C. § 119(e) from U.S. Patent Application No. 63/534,976 filed Aug. 28, 2023, titled “Lithium Sulfide Production and Purification Methods,” the entire contents of which is incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND

Lithium sulfide (Li₂S) is often used as an electrolyte in batteries or as a precursor in the synthesis of more complex electrolyte compounds. Recently, the use of lithium sulfide as an electrolyte or an electrolyte precursor has grown in the field of solid-state batteries. To accommodate this increased use of lithium sulfide, methods for synthesizing lithium sulfide with high yield and low cost are needed.

### SUMMARY

Provided herein are methods of preparing Li₂S. The methods include combining an alkali metal sulfide, a lithium salt, an alcohol, and a hydrocarbon to form a mixture; adding to the mixture a solvent having a density higher than 1.67 g/cm³; and, isolating a Li₂S reaction product from the mixture. In some embodiments, isolating the Li₂S reaction product from the mixture comprises skimming the Li₂S from the surface of the mixture. In some additional embodiments, isolating the Li₂S reaction product from the mixture comprises filtration, centrifugation, or a combination thereof. In still further embodiments, isolating the Li₂S reaction product from the mixture comprises collecting a supernatant. In some additional embodiments, isolating the Li₂S reaction product from the mixture comprises evaporating less than 50% of the alcohol, or evaporating less than 25% of the alcohol, or evaporating less than 10% of the alcohol, or evaporating less than 7% of the alcohol, or evaporating less than 5% of the alcohol. In some embodiments, the method further comprises crystallizing, sonicating, shaking, grinding, or milling the Li₂S reaction product.

In some embodiments, the Li₂S reaction product is a precipitate.

In some embodiments, the alkaline metal sulfide comprises Na₂S, NaSH, K₂S, or a combination thereof.

In some embodiments, the lithium salt comprises a lithium halide. In some aspects, the lithium halide comprises LiBr, LiCl, Lil, LiF or a combination thereof. In some additional embodiments, the lithium salt comprises lithium nitrate, lithium sulfate, or a combination thereof.

In some embodiments, the alcohol comprises an alkanol. In some embodiments, the alcohol comprises ethanol, propanol, or a combination thereof.

In some embodiments, the hydrocarbon comprises pentane, hexane, heptane, octane, decane, undecane, xylene, toluene, paraffins, or a combination thereof.

In some embodiments, the weight ratio of the alcohol to the hydrocarbon is from about 40:60 to about 1:99, such as from about 30:70 to about 2:98, about 25:75 to about 5:95, about 20:80 to about 5:95, about 15:85 to about 5:95, or from about 13:87 to about 5:95.

In some embodiments, the solvent is a non-reactive solvent. In some embodiments, the solvent includes a fluorocarbon. In some examples, the solvent comprises 1,3-dibromopropane, 1,2-dibromopropane, 1,2-diiodoethane, 1,2-dibromobutane, or a combination thereof.

In some embodiments, the Li₂S reaction product and the alcohol are present in a ratio from about 1:1 to about 10:1 by weight before evaporation.

In some embodiments, the method further includes heating the mixture to a temperature from 60° C. to 1° C. below the boiling point of the alcohol, such as from 50° C. to 1° C., 40° C. to 1° C., 30° C. to 1° C. below the boiling point of the alcohol.

Further provided herein are methods for preparing Li₂S. The methods generally include combining Na₂S, LiCl, an alcohol, and a hydrocarbon to form a mixture; forming a Li₂S precipitate; adding to the mixture a solvent having a density higher than 1.67 g/cm³; and, isolating the Li₂S precipitate from the mixture.

Further provided herein are methods for preparing Li₂S. The methods generally include combining Na₂S, LiCl, an alcohol, and a hydrocarbon to form a mixture; forming a Li₂S precipitate; adding to the mixture a solvent that is miscible with the alcohol or the hydrocarbon to form a solvent blend, wherein the average density of the resulting solvent blend is higher than 1.67 g/cm³ and lower than; and isolating the Li₂S precipitate from the mixture. In some embodiments, the methods further include sonicating, shaking, grinding, or milling the Li₂S precipitate.

In some embodiments, the solvent includes 1,3-dibromopropane, 1,2-dibromopropane, 1-2-diiodoethane, diiodomethane, iodomethane, 1,5-diiodopentane, or a combination thereof. In some embodiments, the solvent is a fluorine-based solvent. In some aspects, the fluorine-based solvent does not have a hydrocarbon group. In some additional aspects, the fluorine-based solvent is a perfluoroalkane.

Further provided herein are methods for preparing Li₂S. The methods generally include combining Na₂S and LiCl with a mixture comprising an alcohol and a solvent having a density higher than 1.67 g/cm³; forming a Li₂S precipitate; and isolating the Li₂S precipitate from the mixture.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows a flow chart describing an exemplary method of the present disclosure.

FIG. 2 shows a flow chart describing an exemplary method of the present disclosure.

FIG. 3 shows a flow chart describing an exemplary method of the present disclosure.

FIG. 4 shows a flow chart describing an exemplary method of the present disclosure.

FIG. 5 shows an x-ray diffraction pattern of a composite produced in Example 1.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

Provided herein are methods for preparing lithium sulfide (Li₂S). The methods generally include combining an alkali metal sulfide, a lithium salt, an alcohol, and a hydrocarbon to form a mixture. The alkali metal sulfide and the lithium salt react to form Li₂S reaction product in the mixture. A dense solvent is then added to the mixture. The high density of the solvent separates the Li₂S by adding a dense solvent to a slurry comprising the Li₂S. The increased density from the solvent results in a gravimetric separation of the materials in the mixture. Specifically, the dense solvent is denser than the Li₂S, and so the Li₂S floats to the surface of the mixture where it may be “skimmed” off the top of the mixture or otherwise filtered from the mixture.

In one embodiment, the method initiates by combining an alkali metal sulfide, a lithium salt, an alcohol, and a hydrocarbon to form a mixture. The combining may occur at ambient temperature and pressure conditions, or at elevated temperature and pressure conditions in which the solvent(s) are maintained in a liquid form. The combining may occur in an inert atmosphere, such as nitrogen, argon, helium, etc.

The alkali metal sulfide may comprise any alkali metal sulfide known in the art. Alkali metal sulfides may have the general formula M2S or MSH, wherein M represents the alkali metal. For example, the alkali metal sulfide may comprise lithium sulfide (Li₂S), lithium sulfanide (LiSH), sodium sulfide (Na₂S), sodium hydrosulflide (NaSH), potassium sulfide (K₂S), potassium hydrosulfide (KSH), rubidium sulfide (Rb₂S), rubidium hydrosulfide (RbSH), cesium sulfide (Cs₂S), cesium hydrosulfide (CsSH), or any combination thereof. In exemplary embodiments, the alkali metal sulfide comprises Na₂S, NaSH, K₂S, or any combination thereof.

The lithium salt is soluble in the alcohol and capable of forming at least one lithium-containing product that is soluble in the alcohol and a non-lithium-containing compound that is insoluble in the alcohol. The lithium salt may include lithium nitrate (LiNO₃), or the lithium salt may include a lithium halide, such as lithium chloride (LiCl), lithium bromide (LiBr), lithium iodide (LiI) or any combination thereof.

The lithium salt used may influence the degree of separation achieved. For example, if LiI is used in the initial reaction and the alkali metal sulfide is Na₂S, Li₂S and NaI would be produced; likewise, if LiCl is used in the initial reaction, NaCl would be produced. NaI has a density of about 3.67g/cm³ whereas NaCl has a density of 2.17g/cm³. By increasing the difference in density of the Li₂S and the alkali metal salt, a greater separation effect may be produced.

The alkali metal sulfide and the lithium salt may be added in a ratio such that there is at least one mol of alkali metal from the alkali metal sulfide for each mol of lithium from the lithium salt. However, either the alkali metal sulfide or the lithium salt may be added such that there is a molar excess of either the alkali metal or the lithium.

The alcohol may comprise any alcohol known in the art. Preferably, the alcohol is an alkanol, such as methanol, ethanol, propanol (including n-propanol and isopropanol), butanol (including n-butanol, sec-butanol, iso-butanol, and tert-butanol), pentanol, hexanol, heptanol, octanol, or any combination thereof. In exemplary embodiments, the alcohol includes ethanol, propanol (including n-propanol and isopropanol), or any combination thereof.

The hydrocarbon may comprise a linear or branched, substituted or unsubstituted, saturated or unsaturated, alkane hydrocarbon, such as propane, butane, pentane, hexane, heptane, octane, decane, undecane, dodecane, paraffins, or any combination thereof. Alternatively or additionally, the hydrocarbon may include a substituted or unsubstitued, saturated or unsaturated, cyclic hydrocarbon, such as cyclopentane, cyclohexane, cycloheptane, or any combination thereof. Alternatively or additionally, the hydrocarbon may include an aromatic hydrocarbon, such as xylene (including para-, meta-, and ortho-xylene), toluene, benzene, isoparaffins having a length of 15-25 carbons, or any combination thereof.

The alcohol and the hydrocarbon may be added in a ratio of alcohol: hydrocarbon from about 40:60 to about 1:99. For example, the alcohol and the hydrocarbon may be added in a ratio of alcohol: hydrocarbon from about 40:60 to about 30:70, about 40:60 to about 20:80, about 40:60 to about 10:90, about 40:60 to about 5:95, about 40:60 to about 1:99, about 30:70 to about 1:99, about 20:80 to about 1:99, about 10:90 to about 1:99, about 5:95 to about 1:99, about 30:70 to about 10:90, about 30:70 or about 2:98, about 25:75 to about 5:95, about 20:80 to about 5:95, about 15:85 to about 5:95, or about 13:87 to about 7:93. In some embodiments, the alcohol and the hydrocarbon may be added in a ratio of alcohol: hydrocarbon of about 40:60, about 35:65, about 30:70, about 25:75, about 20:80, about 15:85, about 10:90, about 5:95, about 4:96, about 3:97, about 2:98, or about 1:99.

The alkali metal sulfide, the lithium salt, the alcohol, and the hydrocarbon may be mixed to form the mixture. The mixing may be performed by methods known in the relevant art. The mixing may be performed in an inert atmosphere, such as nitrogen or argon. The mixing may be conducted at room temperature, or the mixing may be conducted at an elevated temperature so long as the elevated temperature is below the boiling point of the solvents in the mixture. Mixing times are not limited so long as a homogeneous mixture is formed.

In some embodiments, the alkali metal sulfide or the lithium salt may be milled. Milling may be performed when the alkali metal sulfide or the lithium salt have a large particle size (e.g., granules or flakes). Milling may also be performed if the starting materials have a relatively low solubility in the alcohol. The milling may include wet milling or dry milling. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art.

Once the alkali metal sulfide, the lithium salt, the alcohol, and the hydrocarbon are combined to form a mixture, the method proceeds by adding to the mixture a solvent having a density higher than 1.67 g/cm³. The solvent may be added to the mixture all at once or may be added in batches. The solvent may be added at ambient temperature and pressure conditions, or at elevated temperature and pressure conditions in which the solvent(s) are maintained in a liquid form. The solvent may be added in an inert atmosphere, such as nitrogen, argon, helium, etc. Solvents with higher density may be used to increase the separation of the alkali metal salt from the lithium salt.

The solvent preferably includes a non-reactive solvent, i.e., a solvent that neither initiates nor participates in a chemical reaction with the alkali metal sulfide, the lithium salt, the alcohol, or the hydrocarbon. Additionally or alternatively, the solvent may be miscible with the alcohol or the hydrocarbon to form a solvent blend, wherein the average density of the resulting solvent blend is higher than 1.67 g/cm³.

In some embodiments, the solvent may comprise an alkane solvent substituted with one or more halogens chosen from fluorine, chlorine, bromine, iodine, or a combination thereof. For example, the alkane solvent may comprise ethane, propane, butane, pentane, hexane, heptane, octane, nonane, decane, undecane, dodecane, or a combination thereof, wherein the alkane solvent is substituted with one or more halogens chosen from fluorine, chlorine, bromine, iodine, or a combination thereof. In some additional embodiments, the solvent may comprise an alkane solvent substituted with two or more halogens chosen from fluorine, chlorine, bromine, iodine, or a combination thereof. For example, the alkane solvent may comprise ethane, propane, butane, pentane, hexane, heptane, octane, nonane, decane, undecane, dodecane, or a combination thereof, wherein the alkane solvent is substituted with two or more halogens chosen from fluorine, chlorine, bromine, iodine, or a combination thereof.

In preferred embodiments, the solvent comprises 1,3-dibromopropane, 1,2-dibromopropane, 1,2-diiodoethane, 1,2-dibromobutane, iodomethanes, diiodomethane, 1,5-diiodopentane, or a combination thereof.

Alternatively, the solvent may include a fluorine-based solvent. In some embodiments, the fluorine-based solvent may include a fluorocarbon. In some additional embodiments, the fluorine-based solvent does not have a hydrocarbon group.

The fluorine-based solvent may include a perfluoroalkane, including linear, branched, or cyclic perfluoroalkanes. For example, the perfluoroalkane may include perfluoromethane, perfluoroethane, perfluoropropane, perfluorobutane, perfluoropentane, perfluorohexane, perfluoroheptane, perfluorooctane, perfluorononane, perfluorodecane, or combinations thereof.

In preferred embodiments, the solvent comprises perfluorohexane, hexadecafluoroheptane, perfluorooctane, perfluoromethylcyclohexane, perfluorononane, perfluoro-1,3-dimethylcyclohexane, perfluorodecalin, octadecafluorodecahydronaphthalene, perfluoromethyldecalin, perfluoroperhydrophenanthrene, or any combination thereof.

After the solvent has been added, the Li₂S reaction product separates via gravity and floats to the surface of the solvent. The method then proceeds by isolating the Li₂S reaction product. Generally, the Li₂S reaction product is present in the form of a precipitate. In some embodiments, the separation of the Li₂S reaction product may be enhanced by sonicating, grinding or milling the mixture to break apart large particles which have agglomerated together.

The ratio of the Li₂S reaction product to the alcohol may be from about 1:1 to about 10:1 by weight. For example, the ratio of the Li₂S reaction product to the alcohol may be from about 1:1 to about 2:1, about 1:1 to about 3:1, about 1:1 to about 4:1, about 1:1 to about 5:1, about 1:1 to about 6:1, about 1:1 to about 7:1, about 1:1 to about 8:1, about 1:1 to about 9:1, about 2:1 to about 10:1, about 3:1 to about 10:1, about 4:1 to about 10:1, about 5:1 to about 10:1, about 6:1 to about 10:1, about 7:1 to about 10:1, about 8:1 to about 10:1, about 9:1 to about 10:1, about 2:1 to about 9:1, about 3:1 to about 7:1, or about 4:1 to about 6:1 by weight. In some additional examples, the ratio of the Li₂S reaction product to the alcohol may be about 1:1, about 1.5:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, or about 10:1 by weight.

Isolating the Li₂S reaction product from the mixture generally comprises skimming the Li₂S from the surface of the mixture. The skimming may be accomplished using a skimmer. The skimmer preferably has a straight edge and a flat base operable to skim the Li₂S reaction product from the surface of the mixture. The skimmer may be perforated to allow residual solvent to pass through the skimmer as it travels over the surface of the mixture.

Isolating the Li₂S reaction product from the mixture may comprise filtration, centrifugation, or a combination thereof. Methods and devices for filtration and centrifugation of a solid-liquid mixture are generally known to those having skill in the art. In some embodiments, the filtration may comprise microfiltration or nanofiltration.

Isolating the Li₂S reaction product from the mixture may comprise collecting a supernatant. Depending on the solvent used, the Li₂S reaction product may not precipitate as a solid, but may still separate from the mixture as a supernatant. The supernatant may be collected by methods known to those having ordinary skill in the art, such as filtration, evaporation, decanting, or combinations thereof.

Isolating the Li₂S reaction product from the mixture may comprise evaporation. Generally, the evaporation comprises evaporating less than about 50 wt % of the alcohol. For example, the evaporation comprises evaporating less than about 45 wt % of the alcohol, less than about 40 wt % of the alcohol, less than about 35 wt % of the alcohol, less than about 30 wt % of the alcohol, less than about 25 wt % of the alcohol, less than about 20 wt % of the alcohol, less than about 15 wt % of the alcohol, less than about 10 wt % of the alcohol, or less than about 5 wt % of the alcohol.

The evaporation may be performed at a temperature from about 60° C. to about 1° C. below the boiling point of the alcohol. For example, the evaporation may be performed at a temperature from about 60° C. to about 50° C., about 60° C. to about 40° C., about 60° C. to about 30° C., about 60° C. to about 20° C., about 60° C. to about 10° C., about 60° C. to about 5° C., about 60° C. to about 1° C., about 50° C. to about 1° C., about 40° C. to about 1° C., about 30° C. to about 1° C., about 20° C. to about 1° C., about 10° C. to about 1° C., or about 5° C. to about 1° C. below the boiling point of the alcohol. In some additional examples, the evaporation may be performed at a temperature that is about 60° C., about 55° C., about 50° C., about 45° C., about 40° C., about 35° C., about 30° C., about 25° C., about 20° C., about 15° C., about 10° C., about 5° C., or about 1° C. below the boiling point of the alcohol.

In some embodiments, the method may further comprise sonicating, shaking grinding, or milling the Li₂S reaction product after it is isolated from the mixture. Methods of sonicating, shaking, grinding, and milling Li₂S are generally known to those having ordinary skill in the art.

The Li₂S may have a particle size (i.e., D₅₀) from about 0.1 microns to about 10 microns. For example, the Li₂S may have a particle size from about 0.1 microns to about 0.5 microns, about 0.1 microns to about 1 micron, about 0.1 microns to about 2.5 microns, about 0.1 microns to about 5 microns, about 0.1 microns to about 7.5 microns, about 0.1 microns to about 10 microns, about 0.5 microns to about 10 microns, about 1 micron to about 10 microns, about 2.5 microns to about 10 microns, about 5 microns to about 10 microns, or about 7.5 microns to about 10 microns. In preferred embodiments, the Li₂S has a particle size of less than 5 microns, such as from about 0.5 microns to about 4 microns.

In an exemplary embodiment, the method comprises preparing Li₂S comprising: combining Na₂S, LiCl, an alcohol, and a hydrocarbon to form a mixture; forming a Li₂S precipitate; adding to the mixture a solvent having a density higher than 1.67 g/cm³; and isolating the Li₂S precipitate from the mixture.

The lithium sulfide may optionally be crystallized. The crystallization may occur through means known to hose having skill in the art.

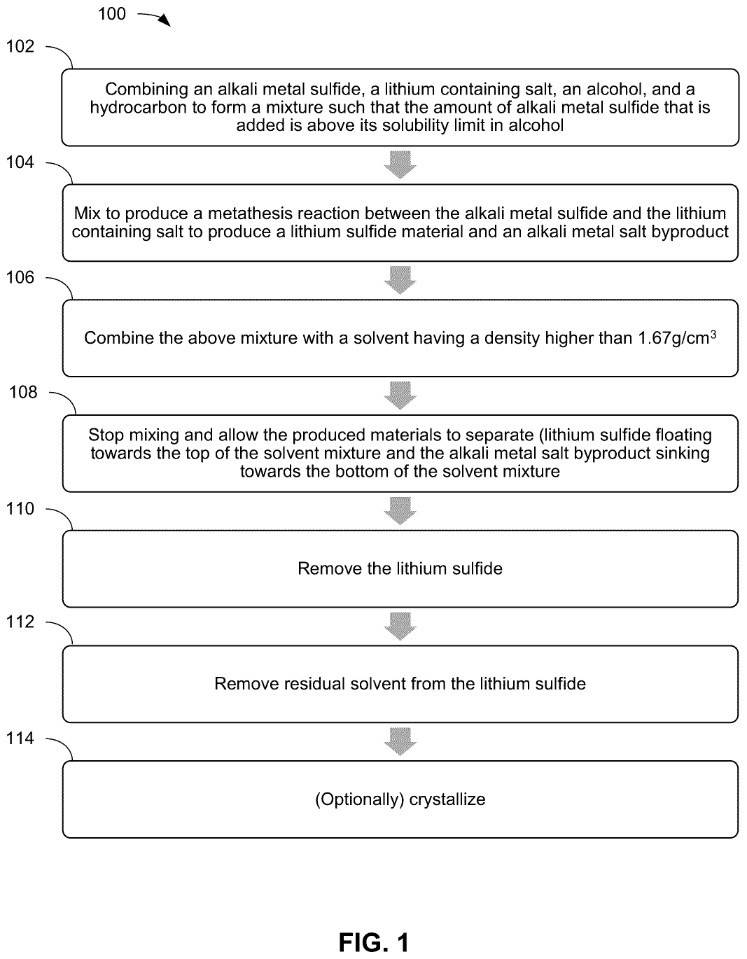

Turning now to FIG. 1, an exemplary method 100 of the present disclosure begins at step 102 by combining an alkali metal sulfide, a lithium salt, an alcohol, and a hydrocarbon to form a mixture such that the amount of alkali metal sulfide that is added is above its solubility limit in the alcohol. Next, at step 104, the metal sulfide, lithium salt, alcohol, and hydrocarbon are mixed to produce a metathesis reaction between the alkali metal sulfide and the lithium salt to produce a lithium sulfide material and an alkali metal salt byproduct. At step 106, the mixture including the lithium sulfide material and the alkali metal salt byproduct is combined with a solvent having a density greater than 1.67 g/cm³. At step 108, the mixing stops, and the materials are allowed to separate. The lithium sulfide floats to the top of the solvent mixture, and the alkali metal salt byproduct sinks to the bottom of the solvent mixture. At step 110, the lithium sulfide which has floated to the top of the mixture is removed. At step 112, any residual solvent is removed from the lithium sulfide. At step 114, optionally, the lithium sulfide is crystallized.

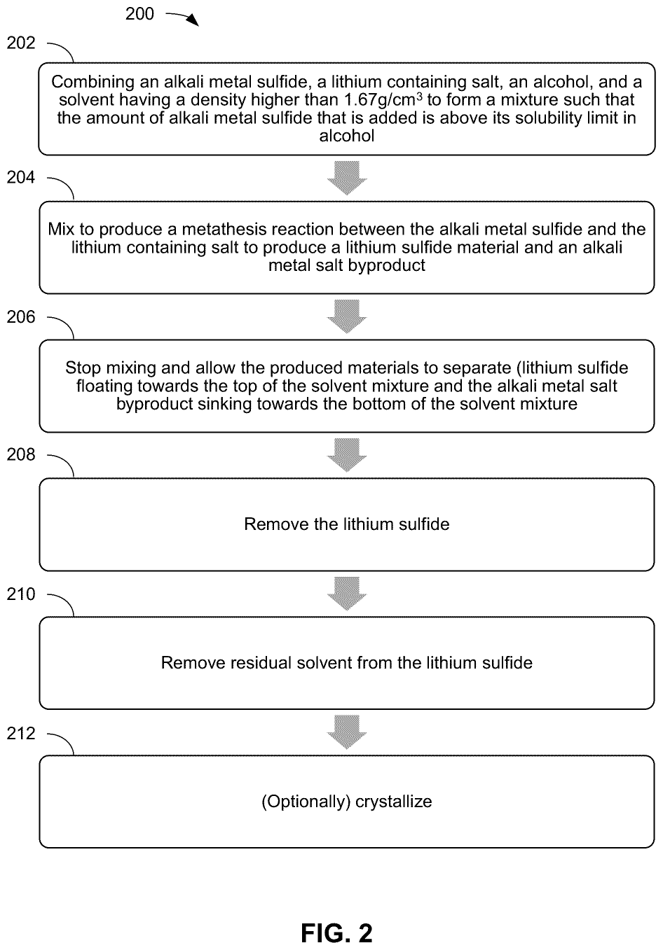

Turning now to FIG. 2, an exemplary method 200 of the present disclosure begins at step 202 by combining an alkali metal sulfide, a lithium salt, an alcohol, and a solvent having a density higher than 1.67 g/cm³ to form a mixture such that the amount of the alkali metal sulfide that is added to the mixture is above its solubility limit in the alcohol. Next, at step 204, the combination formed in step 202 is mixed to produce a metathesis reaction between the alkali metal sulfide and the lithium salt to produce a lithium sulfide material and an alkali metal salt byproduct. At step 206, the mixing stops, and the materials are allowed to separate. The lithium sulfide floats to the top of the solvent mixture, and the alkali metal salt byproduct sinks to the bottom of the solvent mixture. At step 208, the lithium sulfide which has floated to the top of the mixture is removed. At step 210, any residual solvent is removed from the lithium sulfide. At step 212, optionally, the lithium sulfide is crystallized.

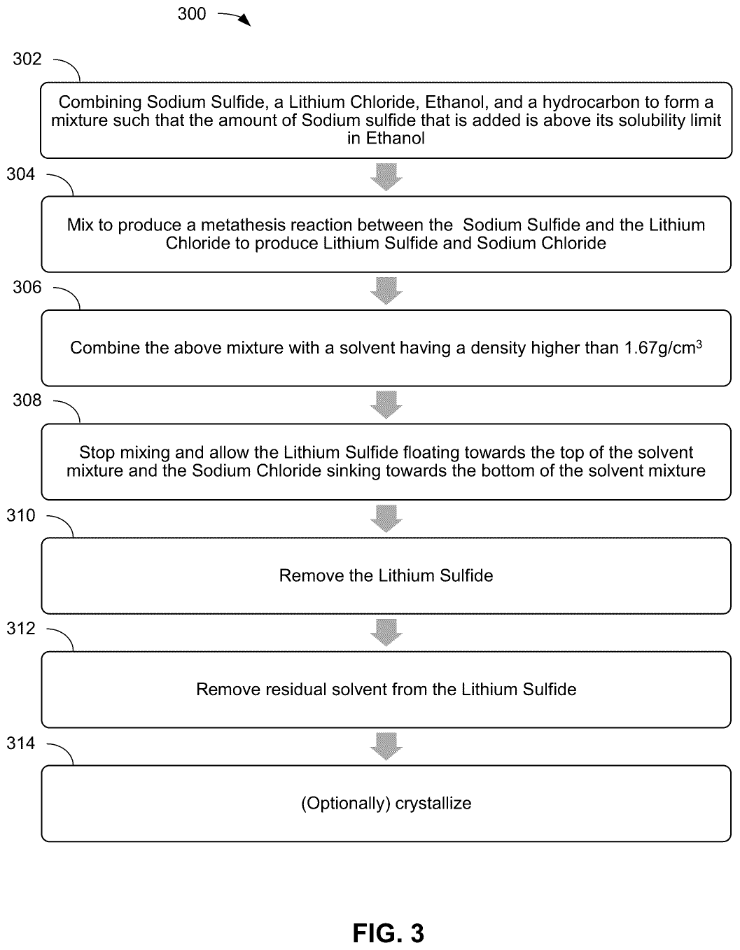

Turning now to FIG. 3, an exemplary method 300 of the present disclosure begins at step 302 by combining sodium sulfide, lithium chloride, ethanol, and a hydrocarbon to form a mixture such that the amount of sodium sulfide that is added is above its solubility limit in ethanol. Next, at step 304, the sodium sulfide, lithium chloride, ethanol, and the hydrocarbon are mixed to produce a metathesis reaction between the sodium sulfide and the lithium chloride to produce lithium sulfide and sodium chloride. At step 306, the mixture produced in step 304 is combined with a solvent having a density higher than 1.67 g/cm³. At step 308, the mixing stops, and the materials are allowed to separate. The lithium sulfide floats to the top of the solvent mixture, and the sodium chloride byproduct sinks to the bottom of the solvent mixture. At step 310, the lithium sulfide which has floated to the top of the mixture is removed. At step 312, any residual solvent is removed from the lithium sulfide. At step 314, optionally. the lithium sulfide is crystallized.

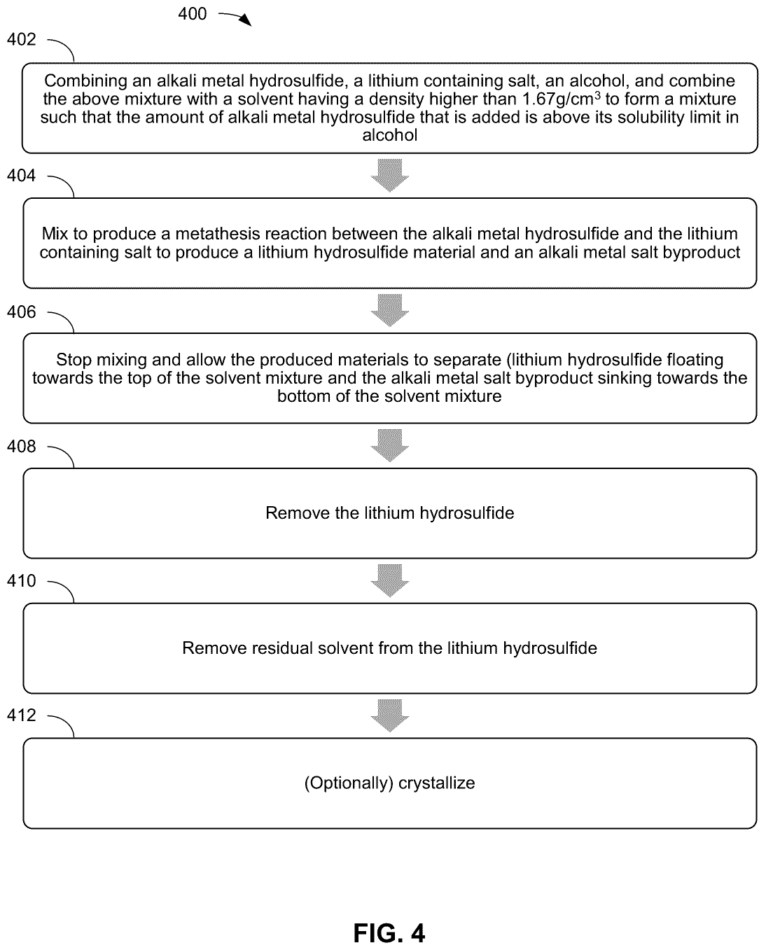

Turning now to FIG. 4, an exemplary method 400 of the present disclosure begins at step 402 by combining an alkali metal hydrosulfide, a lithium salt, an alcohol, and a solvent having a density higher than 1.67 g/cm³ to form a mixture such that the amount of the alkali metal hydrosulfide that is added is above its solubility limit in alcohol. Next, at step 404, the combination formed in step 402 is mixed to produce a metathesis reaction between the alkali metal hydrosulfide and the lithium salt to produce a lithium hydrosulfide material and an alkali metal salt byproduct. At step 406, the mixing stops, and the materials are allowed to separate. The lithium hydrosulfide floats to the top of the solvent mixture, and the alkali metal salt byproduct sinks to the bottom of the solvent mixture. At step 408, the lithium hydrosulfide which has floated to the top of the mixture is removed. At step 410, any residual solvent is removed from the lithium hydrosulfide. At step 412, optionally, the lithium hydrosulfide is crystallized.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

### ENUMERATED EMBODIMENTS

Embodiment 1: A method of preparing Li₂S, the method comprising:
combining an alkali metal sulfide, a lithium salt, an alcohol, and a hydrocarbon to form a mixture;
adding to the mixture a solvent having a density higher than 1.67 g/cm³; and,
isolating a Li₂S reaction product from the mixture.

Embodiment 2: The method of embodiment 1, wherein the alkaline metal sulfide comprises Na₂S, NaSH, K₂S, or a combination thereof.

Embodiment 3: The method of embodiment 1 or 2, wherein the lithium salt comprises a lithium halide.

Embodiment 4: The method of embodiment 3, wherein the lithium halide comprises LiBr, LiCl, LiI, LiF or a combination thereof.

Embodiment 5: The method of any one of embodiments 1-4, wherein the lithium salt comprises lithium nitrate, lithium sulfate, or a combination thereof.

Embodiment 6: The method of any one of embodiments 1-5, wherein the alcohol comprises an alkanol.

Embodiment 7: The method of any one of embodiments 1-6, wherein the alcohol comprises ethanol, propanol, or a combination thereof.

Embodiment 8: The method of any one of embodiments 1-7, wherein the hydrocarbon comprises pentane, hexane, heptane, octane, decane, undecane, xylene, toluene, paraffins, or a combination thereof.

Embodiment 9: The method of any one of embodiments 1-8, wherein the weight ratio of the alcohol to the hydrocarbon is from about 40:60 to about 1:99.

Embodiment 10: The method of any one of embodiments 1-9, wherein the weight ratio of the alcohol to the hydrocarbon is from about 30:70 to about 2:98.

Embodiment 11: The method of any one of embodiments 1-10, wherein the weight ratio of the alcohol to the hydrocarbon is from about 25:75 to about 5:95.

Embodiment 12: The method of any one of embodiments 1-11, wherein the weight ratio of the alcohol to the hydrocarbon is from about 20:80 to about 5:95.

Embodiment 13: The method of any one of embodiments 1-12, wherein the weight ratio of the alcohol to the hydrocarbon is from about 15:85 to about 5:95.

Embodiment 14: The method of any one of embodiments 1-13, wherein the weight ratio of the alcohol to the hydrocarbon is from about 13:87 to about 7:93.

Embodiment 15: The method of any one of embodiments 1-14, wherein the solvent is a non-reactive solvent.

Embodiment 16: The method of any one of embodiments 1-15, wherein the solvent comprises a fluorocarbon.

Embodiment 17: The method of any one of embodiments 1-16, wherein the solvent comprises 1,3-dibromopropane, 1,2-dibromopropane, 1,2-diiodoethane, 1,2-dibromobutane, or a combination thereof.

Embodiment 18: The method of any one of embodiments 1-17, wherein isolating the Li₂S reaction product from the mixture comprises skimming the Li₂S from the surface of the mixture.

Embodiment 19: The method of any one of embodiments 1-18, wherein isolating the Li₂S reaction product from the mixture comprises filtration, centrifugation, or a combination thereof.

Embodiment 20: The method of any one of embodiments 1-19, wherein isolating the Li₂S reaction product from the mixture comprises collecting a supernatant.

Embodiment 21: The method of any one of embodiments 1-20, wherein isolating the Li₂S reaction product from the mixture comprises evaporating less than 50% of the alcohol.

Embodiment 22: The method of any one of embodiments 1-21, wherein isolating the Li₂S reaction product from the mixture comprises evaporating less than 25% of the alcohol.

Embodiment 23: The method of any one of embodiments 1-22, wherein isolating the LieS reaction product from the mixture comprises evaporating less than 10% of the alcohol.

Embodiment 24: The method of any one of embodiments 1-23, wherein isolating the Li₂S reaction product from the mixture comprises evaporating less than 7% of the alcohol.

Embodiment 25: The method of any one of embodiments 1-24, wherein the isolating a Li₂S reaction product from the mixture comprises evaporating less than 5% of the alcohol.

Embodiment 26: The method of any one of embodiments 1-25, wherein the Li₂S reaction product and the alcohol are present in a ratio from about 1:1 to about 10:1 by weight before evaporation.

Embodiment 27: The method of any one of embodiments 1-26, wherein the Li₂S reaction product is a precipitate.

Embodiment 28: The method of any one of embodiments 1-27, the method further comprising heating the mixture to a temperature from 30° C. to 1° C. below the boiling point of the alcohol.

Embodiment 29: The method of any one of embodiments 1-28, the method further comprising heating the mixture to a temperature from 40° C. to 1° C. below the boiling point of the alcohol.

Embodiment 30: The method of any one of embodiments 1-29, the method further comprising heating the mixture to a temperature from 50° C. to 1° C. below the boiling point of the alcohol.

Embodiment 31: The method of any one of embodiments 1-30, the method further comprising heating the mixture to a temperature from 60° C. to 1° C. below the boiling point of the alcohol.

Embodiment 32: The method of any one of embodiments 1-31, further comprising crystallizing, sonicating, shaking, grinding, or milling the Li₂S reaction product.

Embodiment 33: A method of preparing LieS, the method comprising:
combining Na₂S, LiCl, an alcohol, and a hydrocarbon to form a mixture;
forming a Li₂S precipitate;
adding to the mixture a solvent having a density higher than 1.67 g/cm³; and,
isolating the Li₂S precipitate from the mixture.

Embodiment 34: A method of preparing Li₂S, the method comprising:
combining Na₂S, LiCl, an alcohol, and a hydrocarbon to form a mixture;
forming a Li₂S precipitate;
adding to the mixture a solvent that is miscible with the alcohol or the hydrocarbon to form a solvent blend, wherein the average density of the resulting solvent blend is higher than 1.67 g/cm³; and,
isolating the Li₂S precipitate from the mixture.

Embodiment 35: The method of embodiment 34, wherein the solvent comprises 1,3-dibromopropane, 1,2-dibromopropane, 1-2-diiodoethane, diiodomethane, iodomethane, 1,5-diiodopentane, or a combination thereof.

Embodiment 36: The method of embodiment 34, wherein the solvent is a fluorine-based solvent.

Embodiment 37: The method of embodiment 36, wherein the fluorine-based solvent does not have a hydrocarbon group.

Embodiment 38: The method of embodiment 36, wherein the fluorine-based solvent is a perfluoroalkane.

Embodiment 39: The method of any one of embodiments 34-38, further comprising sonicating, shaking, grinding, or milling the Li₂S precipitate.

Embodiment 40: A method of preparing Li₂S, the method comprising:
combining Na₂S and LiCl with a mixture comprising an alcohol and a solvent having a density higher than 1.67 g/cm³;
forming a Li₂S precipitate; and
isolating the Li₂S precipitate from the mixture.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

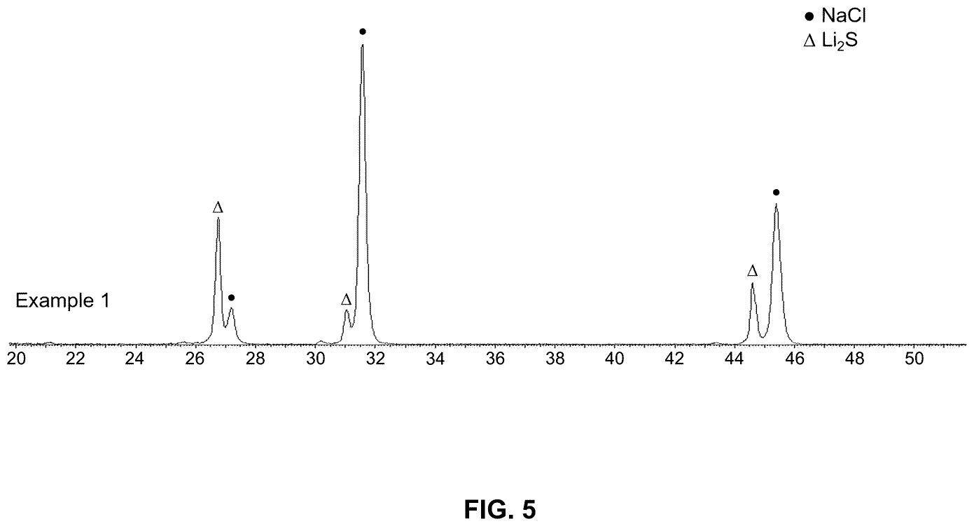

A composite was produced by combining 1 gram of anhydrous Na₂S, 0.06 g elemental Sulfur, and 1.2 g anhydrous LiCl to a 20 mL vial containing a magnetic stir bar. To the vial, 16 grams of xylenes and 0.8 grams of ethanol were added. The vial was then sealed and stirred on a stir plate to react for 48 hours. After the 48 hours, the solvents were filtered off leaving a composite containing LiCl, NaCl, and Li₂S_{1.1}. This composite was then dried at 70° C. under vacuum conditions for 1 hour. The excess sulfur in the lithium polysulfide was removed in this step to form elemental sulfur, which sublimed out of the composite. The final composition, the x-ray diffraction pattern of which is shown in FIG. 5, contained about 26.8% by weight Li₂S, about 68.1% by weight NaCl, and about 5.2% by weight LiCl.

### Example 2

An amount of the composite from Example 1 was placed in a vial containing a magnetic stir bar. 10 mL of perfluoro-1,3-dimethylcyclohexane, which has a density of about 1.828 g/mL, was added to the vial. The vial containing all of the materials was placed on a stir plate and the materials were allowed to mix for 10 minutes. The mixing was then stopped, and the composite was left to settle for 12 hours. After 12 hours, the composite had separated into two sections, one section collected on the bottom of the vial while the other collected on the top of the perfluoro-1,3-dimethylcyclohexane. An aliquot of the composite from the top section was removed from the vial and the solvent was removed. The material from the top section was about 47% Li₂S and 53% NaCl.

By mixing Li₂S and an alkali metal salt-containing composite with a high density halogenated hydrocarbon, a density separation effect was produced. The difference in density separated the NaCl from the Li₂S in a composite, thereby changing the overall Li₂S content from 26.8% by weight to about 47% by weight, or an increase of 68%.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A method of preparing Li₂S, the method comprising:
combining an alkali metal sulfide, a lithium salt, an alcohol, and a hydrocarbon to form a mixture;
adding to the mixture a solvent having a density higher than 1.67 g/cm³; and,
isolating a Li₂S reaction product from the mixture.

2. The method of claim 1, wherein the alkaline metal sulfide comprises Na₂S, NaSH, K₂S, or a combination thereof.

3. The method of claim 1, wherein the lithium salt comprises a lithium halide.

4. The method of claim 3, wherein the lithium halide comprises LiBr, LiCl, LiI, LiF or a combination thereof.

5. The method of claim 1, wherein the lithium salt comprises lithium nitrate, lithium sulfate, or a combination thereof.

6. The method of claim 1, wherein the alcohol comprises an alkanol.

7. The method of claim 1, wherein the alcohol comprises ethanol, propanol, or a combination thereof.

8. The method of claim 1, wherein the hydrocarbon comprises pentane, hexane, heptane, octane, decane, undecane, xylene, toluene, paraffins, or a combination thereof.

9. The method of claim 1, wherein the weight ratio of the alcohol to the hydrocarbon is from about 40:60 to about 1:99.

10. The method of claim 1, wherein the weight ratio of the alcohol to the hydrocarbon is from about 25:75 to about 5:95.

11. The method of claim 1, wherein the weight ratio of the alcohol to the hydrocarbon is from about 13:87 to about 7:93.

12. The method of claim 1, wherein the solvent comprises a fluorocarbon.

13. The method of claim 1, wherein the solvent comprises 1,3-dibromopropane, 1,2-dibromopropane, 1,2-diiodoethane, 1,2-dibromobutane, or a combination thereof.

14. The method of claim 1, wherein isolating the Li₂S reaction product from the mixture comprises skimming the Li₂S from the surface of the mixture.

15. The method of claim 1, wherein isolating the Li₂S reaction product from the mixture comprises filtration, centrifugation, or a combination thereof.

16. The method of claim 1, wherein isolating the Li₂S reaction product from the mixture comprises collecting a supernatant.

17. The method of claim 1, wherein isolating the Li₂S reaction product from the mixture comprises evaporating less than 50% of the alcohol.

18. The method of claim 1, wherein the Li₂S reaction product and the alcohol are present in a ratio from about 1:1 to about 10:1 by weight before evaporation.

19. The method of claim 1, the method further comprising heating the mixture to a temperature from 30° C. to 1° C. below the boiling point of the alcohol.

20. The method of claim 1, further comprising crystallizing, sonicating, shaking, grinding, or milling the Li₂S reaction product.

21. A method of preparing Li₂S, the method comprising:
combining Na₂S, LiCl, an alcohol, and a hydrocarbon to form a mixture;
forming a Li₂S precipitate;
adding to the mixture a solvent having a density higher than 1.67 g/cm³; and,
isolating the Li₂S precipitate from the mixture.

22. A method of preparing Li₂S, the method comprising:
combining Na₂S, LiCl, an alcohol, and a hydrocarbon to form a mixture;
forming a Li₂S precipitate;
adding to the mixture a solvent that is miscible with the alcohol or the hydrocarbon to form a solvent blend, wherein the average density of the resulting solvent blend is higher than 1.67 g/cm³; and,
isolating the Li₂S precipitate from the mixture.

23. The method of claim 22, wherein the solvent comprises 1,3-dibromopropane, 1,2-dibromopropane, 1-2-diiodoethane, diiodomethane, iodomethane, 1,5-diiodopentane, or a combination thereof.

24. The method of claim 22, wherein the solvent is a fluorine-based solvent.

25. The method of claim 24, wherein the fluorine-based solvent does not have a hydrocarbon group.

26. The method of claim 24, wherein the fluorine-based solvent is a perfluoroalkane.

27. The method of claim 22, further comprising sonicating, shaking, grinding, or milling the Li₂S precipitate.
